(19) United States
(12) Patent Application Publication
(10) Pub. No.: US 2010/0128640 A1
(43) Pub. Date: May 27, 2010

(54) APPARATUS AND METHOD FOR CALCULATING AN OPTIMUM ROUTE BETWEEN A PAIR OF NODES IN A COMMUNICATION NETWORK

(75) Inventor: Takuya OKAMOTO, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/619,912

(22) Filed: Nov. 17, 2009

(30) Foreign Application Priority Data
Nov. 27, 2008 (JP) 2008-301986

(51) Int. Cl. H04L 12/28

(52) U.S. Cl. 370/255; 370/400

(57) ABSTRACT

A node apparatus and method for calculating a route between a pair of nodes in a communication network. There is provided a topology table for storing topology information on links being used by an existing path in the communication network, and a virtual topology table is generated. The virtual topology table stores topology information in which links being used by the existing path are virtually released and made unused. An optimum route for a path connecting a pair of nodes in the communication network is computed on the basis of the virtual topology table.

### CROSS-REFERENCE TO RELATED APPLICATION

This application is based upon and claims the benefit of priority of the prior Japanese Patent Application No. 2008-301986, filed on Nov. 27, 2008, the entire contents of which are incorporated herein by reference.

### FIELD

The present invention relates to apparatus and method for calculating an optimum route between a pair of nodes in a communication network.

### BACKGROUND

In recent years, MPLS (Multi-Protocol Label Switching) that introduces a concept of label switching into an IP network is used so as to operate the network on the basis of a path. Further, as an autonomous decentralized technology for operating a path network, GMPLS (Generalized Multi-Protocol Label Switching) is discussed in the CCAMP (Common Control and Measurement Plane)-WG (Working Group) of the IETF (Internet Engineering Task Force), the OIF (Optical Internetworking Forum) and the ITU (International Telecommunication Union) so as to be standardized, and is partially being put to practicable use. Here, the path network includes not only an IP network but also a TDM (Time Division Multiplexing) network such as SDH (Synchronous Digital Hierarchy)/SONET (Synchronous Optical Network), and a wavelength switch network.

The GMPLS contributes to standardizing path opening between different devices, enabling a BoD (Bandwidth on Demand) service for opening a path at high speed, and the efficient operation of a network becomes possible with unified management of a plurality of layers.

According to the GMPLS, an IP packet is provided with an MPLS header, and transferred in the network on the basis of a label in the MPLS header. Such a mechanism of packet transfer is called a label switch. Various items such as a time slot, a wavelength group, and a fiber can be applied as the label.

In the case of route computation for setting a path in the GMPLS, a shortest route is automatically computed by means of a routing protocol called OSPF (Open Shortest Path First).

The OSPF is a routing protocol of a link state type that uses a link state algorithm. According to the link state algorithm, all routers (nodes) in one network (of a particular area) manage the same database. Link state information (something analogous to a map) of the whole system which is a network having a common routing protocol, is written in the database such that reachable networks, routers interconnecting the reachable networks, and cost required for each of such interconnections can be retrieved therefrom.

Further, according to the OSPF, a Shortest Path Tree (SPT) is built on the basis of the above information. The SPT describes network topology as viewed from the device (node) itself, and a route to be set at an IP routing table is determined in accordance with the network topology. Messages exchanged in accordance with the OSPF protocol includes:

(1) A Hello packet of TYPE 1 that establishes Neighbor, selects DR (Designated Router)/BDR (Backup Designated Router), and checks survival of Neighbor/Adjacency (neighbor relationships);

(2) A Database Description packet of TYPE 2 that exchanges an LSDB (Link State Database);

(3) A Link State Request packet of TYPE 3 that makes a request for an LSA (Link State Advertisement) to be transmitted;

(4) A Link State Update packet of TYPE 4 that exchanges an LSA; and

(5) A Link State Acknowledgement packet of TYPE 5 that acknowledges receipt of an LSA.

According to the GMLPS, respective nodes cooperate with each other to perform controls such as the establishment/release of a path and the setting of state information, by using the RSVP (Resource reSerVation Protocol). Messages exchanged in accordance with the RSVP include:

(1) A Path message that is transferred from an upstream node to a downstream node, and is used as a trigger for various settings such as setting or releasing of a path;

(2) A Resv message that is transferred from a downstream node to an upstream node, and is used as a response to various settings such as a bandwidth reservation;

(3) A PathErr message that is transferred from a downstream node to an upstream node, and is used as an error response to the Path message;

(4) A PathTear message that is transferred from an upstream node to a downstream node, and is used as a trigger for forced path release; and

(5) A Notify message that is transferred from one node to another node, and is used for a point-to-point data transfer between nodes such as notification of error information.

According to the RSVP, the nodes can transfer data on a hop-by-hop or point-to-point basis among the nodes by using these messages so as to manage a path.

Japanese Laid-open Patent Publication No. 2001-217839 discloses a method of switchover from a non-optimum route to the optimum route when a path being used becomes free and available.

### SUMMARY

According to an aspect of an embodiment, there is provided a topology table for storing topology information on links being used by an existing path in the communication network, and a virtual topology table is generated. The virtual topology table stores topology information in which links being used by the existing path are virtually released and made unused. An optimum route for a path connecting a pair of nodes in the communication network is computed on the basis of the virtual topology table.

The object and advantages of the invention will be realized and attained by means of the elements and combinations particularly pointed out in the claims.

It is to be understood that both the foregoing general description and following detailed description are exemplary and explanatory and are not restrictive of the invention, as claimed.

### BRIEF DESCRIPTION OF THE DRAWINGS

FIG. 1 is a schematic diagram illustrating a procedure for calculating an optimum route in a network according to a GMPLS;

FIG. 2 is a schematic diagram illustrating an example of a message sequence for setting a path;

FIG. 3 is a schematic diagram illustrating an example of a message sequence when a failure is detected;

FIG. 4 is a diagram illustrating an example of a network;

FIG. 5 is a diagram illustrating an example of a shortest route in a network;

FIG. 6 is a diagram illustrating an example of an optimum route in a network;

FIG. 7 is a diagram illustrating an example of a route computed as a shortest route in a network;

FIG. 8 is a diagram illustrating an example of a configuration of a node apparatus for performing a path setting process, according to an embodiment;

FIG. 9 is a diagram illustrating an example of a format of a virtual path-release Path message, according to an embodiment;

FIG. 10 is a diagram illustrating an example of a virtually released path, according to an embodiment;

FIG. 11 is a diagram illustrating an example of an optimum route, according to an embodiment;

FIG. 12 is a diagram illustrating an example of a flowchart for re-computing a path by an initial node, according to an embodiment;

FIG. 13 is a diagram illustrating an example of a flowchart for re-computing a path by a down stream node, according to an embodiment;

FIG. 14 is a diagram illustrating an example of an operation sequence of a route re-computation process, according to an embodiment;

FIG. 15A is a diagram illustrating an example of an operation sequence of a path switching process, according to an embodiment;

FIG. 15B is a diagram illustrating an example of an operation sequence of a path release process, according to an embodiment;

FIG. 16 is a diagram illustrating an example of a configuration of a virtual path release Notify message, according to an embodiment;

FIG. 17 is a diagram illustrating an example of an operation sequence of a route re-computation process performed by an initial node, according to an embodiment;

FIG. 18 is a diagram illustrating an example of an operation sequence of a route re-computation process, according to an embodiment;

FIG. 19 is a diagram illustrating an example of a flowchart for re-computing an existing path, according to an embodiment; and

FIG. 20 is a diagram illustrating an example of an operation sequence of a route re-computation process, according to an embodiment.

### DESCRIPTION OF EMBODIMENTS

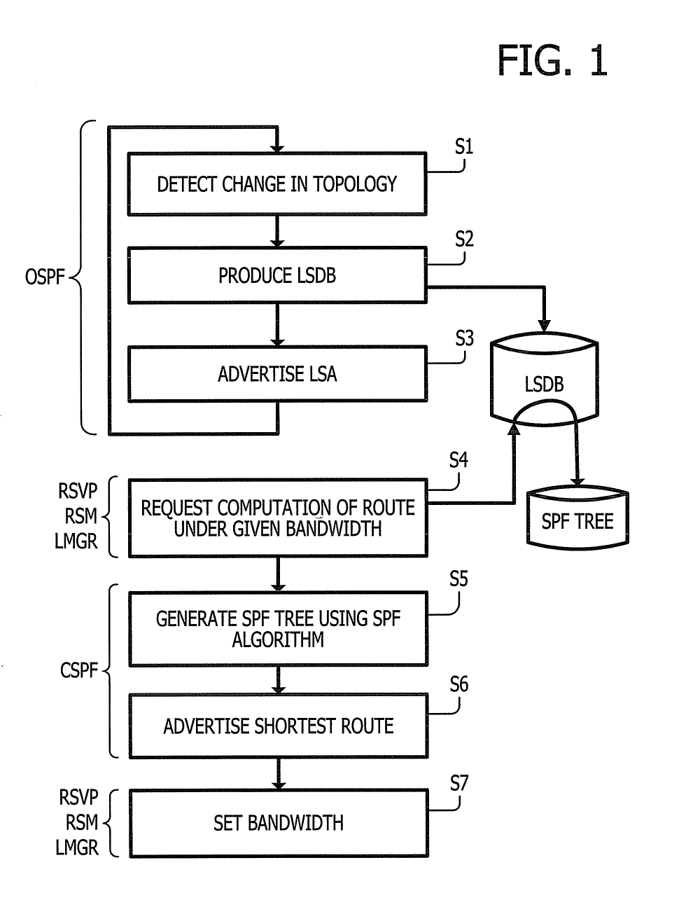

FIG. 1 is a schematic diagram illustrating a procedure for calculating an optimum route in a network according to a GMPLS, in which nodes exchange bandwidth data thereamong and share topology data. In FIG. 1, a change in topology is detected (in step S1) by the OSPF protocol. Then, an LSDB is produced (in step S2), and an LSA is advertised by flooding (in step S3).

Route computation is requested under a given bandwidth (in step S4) in accordance with the RSVP. Then, according to the SPF (Shortest Path First) algorithm, an SPF tree is generated in accordance with the CSPF (Constrained Shortest Path First). A shortest route is notified (in step S6) in accordance with the CSPF. Then, a bandwidth is set (in step S7) in accordance with the RSVP.

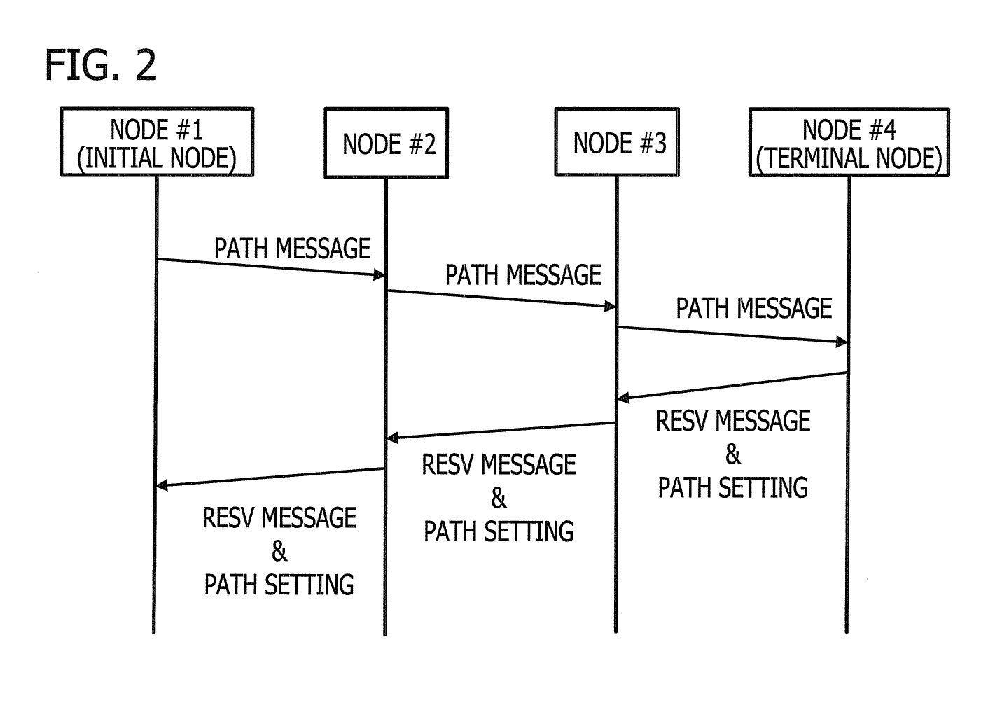

FIG. 2 is a schematic diagram illustrating an example of a message sequence for setting a path, in which the path is set to a route from an initial node #1 to a terminal node #4, on a hop-by-hop basis, by using Path and Resv messages of the RSVP.

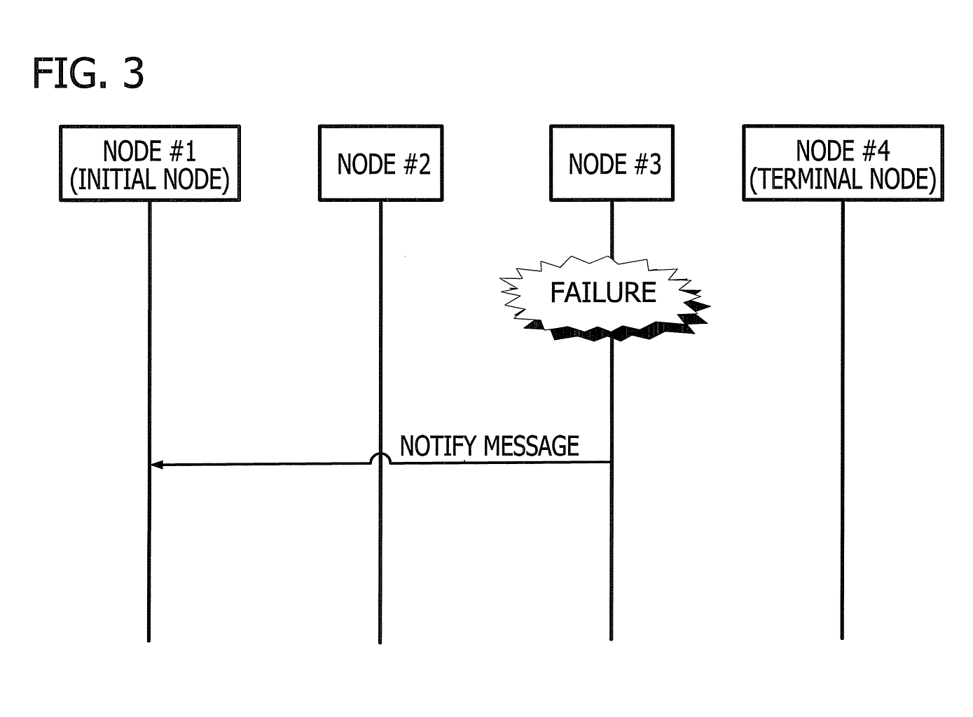

FIG. 3 is a schematic diagram illustrating an example of a message sequence, in which a node #3 that has detected a failure notifies the initial node #1 of failure information on a point-to-point basis by using a Notify message of the RSVP.

When the topology of a network in which an existing path is being operated, is changed, for example, due to a change in the network configuration, the route presently selected for the existing path may be replaced with a more proper route in some cases.

However, according to the ordinary OSPF, since route computation is performed only for links (transmission lines) that are not being operated by an existing path, the existing route for the existing path is being maintained without change. Therefore, an optimum route capable of replacing the existing path cannot be computed.

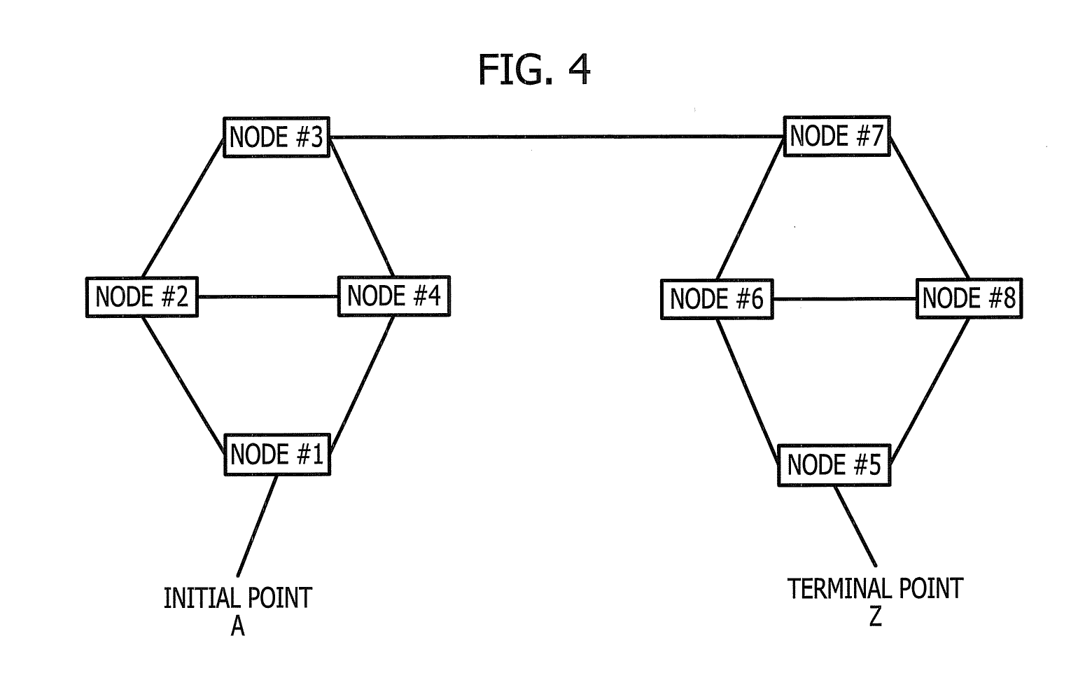

FIG. 4 is a diagram illustrating an example of a network configuration. In FIG. 4, for example, it is assumed that a path is set from an initial point A to a terminal point Z in a network including nodes #1 to #8.

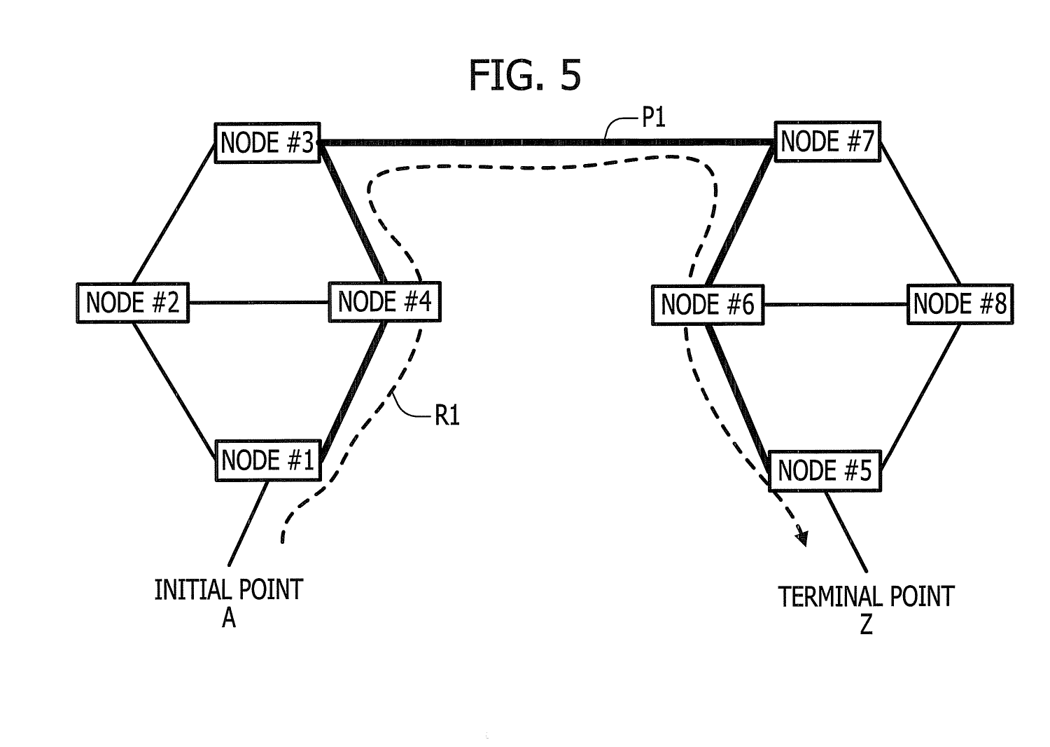

FIG. 5 is a diagram illustrating an example of a shortest route in the network depicted in FIG. 4. A shortest route from the initial point A to the terminal point Z in FIG. 4 can be given by the route R1 of node #1 (connected to initial point A), the node #4, the node #3, the node #7, the node #6, and the node #5 (connected to terminal point Z), having a route length of 5 hops, as depicted by a dotted line with an arrow in FIG. 5. In the case, it is assumed that a path P1 is set as depicted by a bold solid line along the route R1 in FIG. 5.

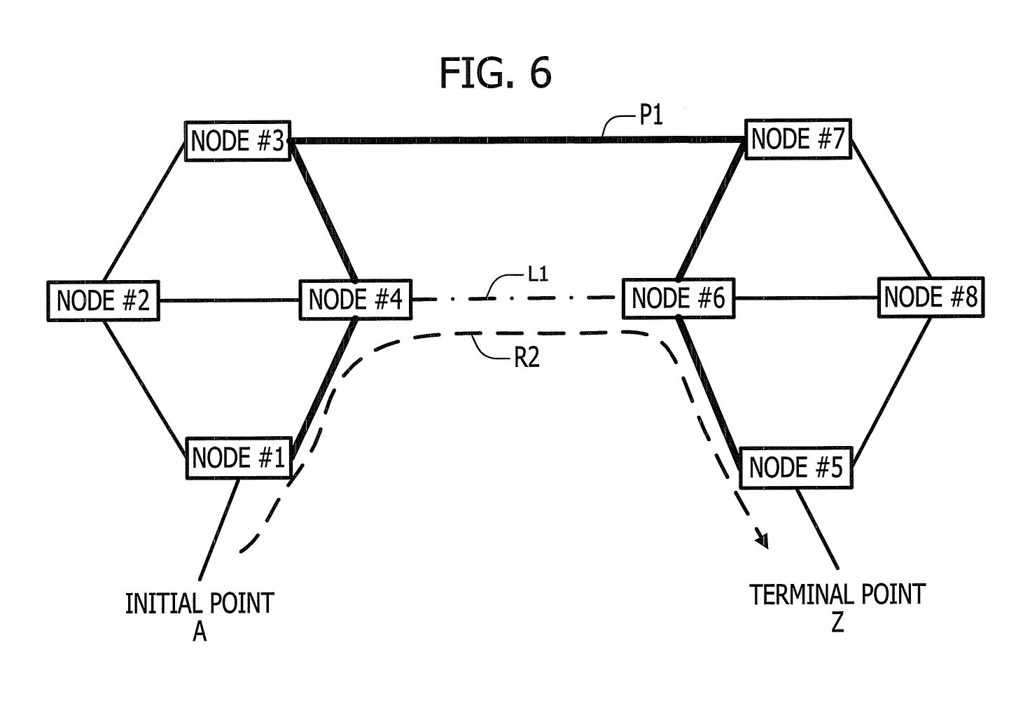

FIG. 6 is a diagram illustrating an example of an optimum route in a network. When the network configuration (topology) is changed such that the nodes #4 and #6 are directly connected to each other by a link L1 (depicted by a dashed-dotted line with an arrow in FIG. 6) in the above network, the shortest route from the initial point A to the terminal point Z is given by the route R2 of node #1 (connected to the initial point A), the node #4, the node #6, and the node #5 (connected to the terminal point Z), having a rout length of 3 hops, as depicted by a dotted line with an arrow in FIG. 6. Therefore, network use efficiency can be optimized by resetting a path along the route R2 (depicted by a dotted line with an arrow in FIG. 6) instead of the existing path P1 (depicted by a bold solid line along a dotted line with an arrow in FIG. 5).

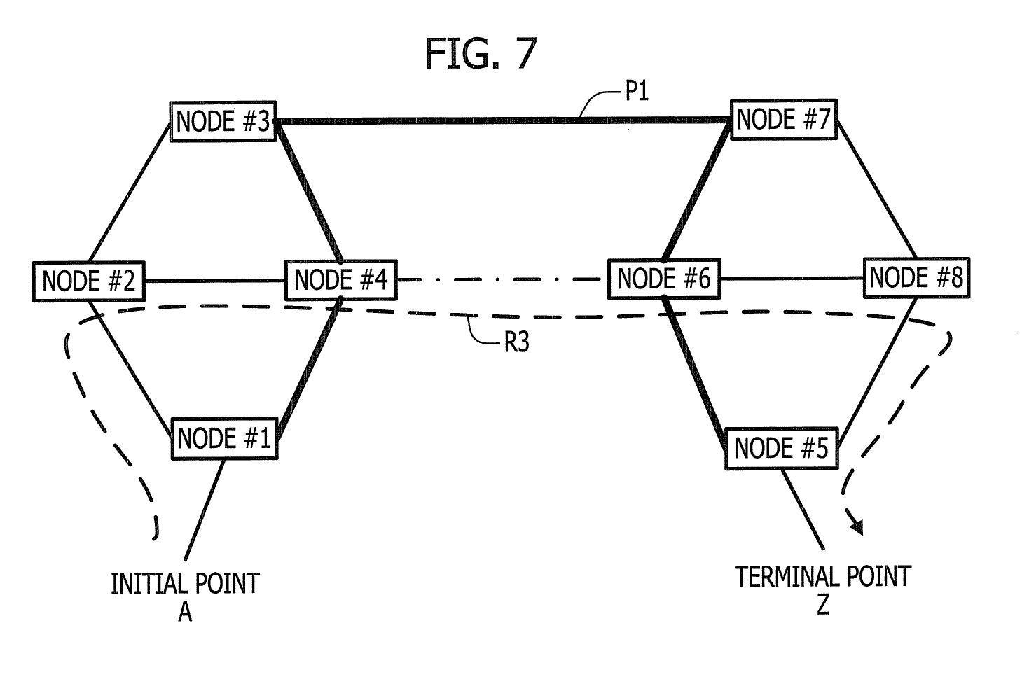

FIG. 7 is a diagram illustrating an example of a route computed as a shortest route in a network.

However, since only unused links (unused transmission lines) are searched for the shortest route in the case of route computation according to the ordinary OSPF protocol, a route actually computed is given by the route R3 of the node #1 (connected to the initial point A), the node #2, the node #4, the node #6, the node #8, and the node #5 (connected to the terminal point Z), having a route length of 5 hops, as depicted by a dotted line with an arrow in FIG. 7. This causes a problem that the optimum route R2 (depicted by the dotted line with the arrow in FIG. 6) cannot be obtained in the case.

An embodiment will be explained below with reference to the drawings.

### (Configuration of Node Device)

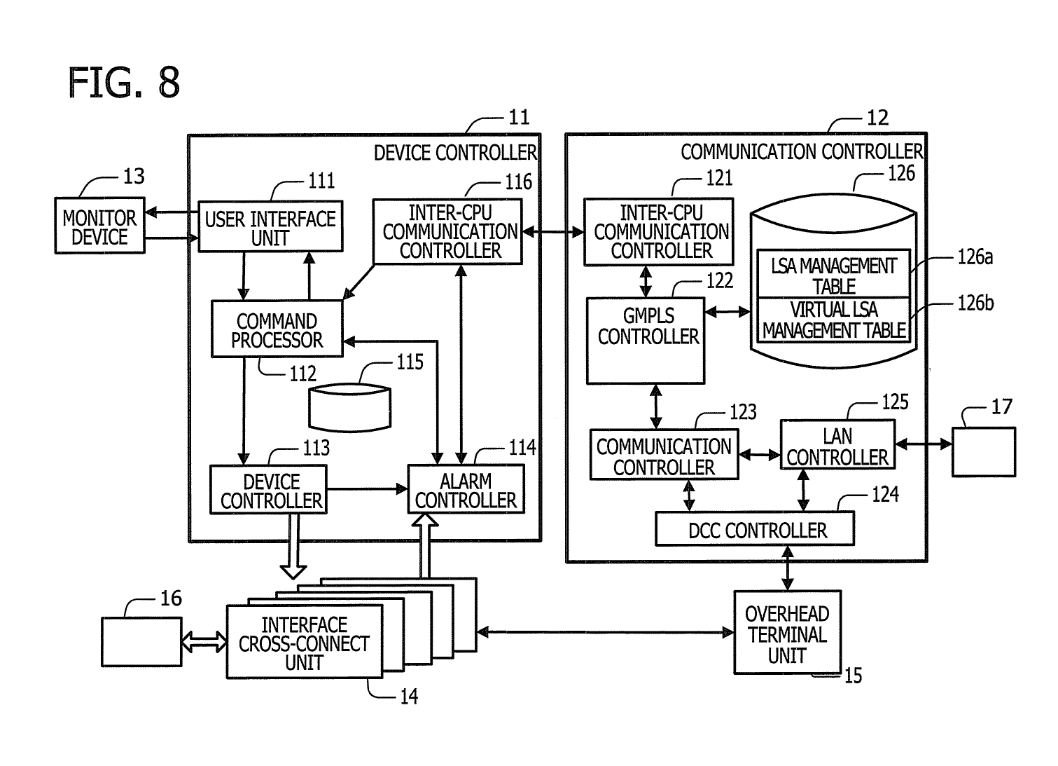

FIG. 8 is a diagram illustrating an example of a configuration of a node apparatus for performing a path setting process, according to an embodiment. As depicted in FIG. 8, the node apparatus includes a device controller 11, a communication controller 12, a monitor 13 connected to the device controller 11, an interface cross-connect unit 14 connected to the device controller 11 and configured to perform opt-electric conversion and switching operation, and an overhead terminal unit 15 for SDH/SONET which is connected between the communication controller 12 and the interface cross-connect unit 14.

The device controller 11 is configured to process an optical main signal, and the communication controller 12 is configured to process a Path message and a Resv message which flow through a monitoring line.

The device controller 11 includes a user interface unit 111 connected to the monitor device 13, a command processor 112 connected with the user interface unit 111, a device controller 113 and an alarm controller 114 both which are connected to the command processor 112 and the interface cross-connect unit 14, a database (DB) 115 storing path setting data, and an inter-CPU communication controller 116 which is connected to the command processor 112 and the alarm controller 114. Further, the device controller 113 is connected to the alarm controller 114.

The monitor device 13 sends a path setting command to the user interface unit 111. The device controller 113 sets a path to a cross-connect part included in the interface cross-connect unit 14. The interface cross-connect unit 14 optically connects a main signal to an adjacent node apparatus, and communicates with the adjacent node apparatus 16 by using a Data Communication Channel (DCC) of an overhead of the main signal. Further, the interface cross-connect unit 14 notifies the alarm controller 114 of a path alarm that has occurred at the cross-connect part in the interface cross-connect unit 14.

Further, the communication controller 12 includes an inter-CPU communication controller 121 connected to the inter-CPU communication controller 116 of the device controller 11, a GMPLS controller 122 connected to the inter-CPU communication controller 121, a database 126 that is connected to the GMPLS controller 122 and storing an LSA management table 126a configured to manage topology data of the network and a virtual LSA management table 126b configured to manage topology data from which a particular path is virtually removed, a communication controller 123 connected to the GMPLS controller 122, a DCC controller 124 that is connected to both the communication controller 123 and the overhead terminal unit 15 and configured to control the data communication channel (DCC) so as to send and receive a packet for controlling GMPLS by using DCC communication, and a LAN controller 125 that is connected to the adjacent node apparatus or a remote monitor device 17 and configured to send and receive the packet for controlling GMPLS by using LAN communication.

That is, the communication controller 12 is configured to send and receive a packet for controlling GMPLS through the data communication channel (DCC) or the LAN.

### First Embodiment

According to a first embodiment, a virtual path-release Path message that contains information (so called “CALLID”) for uniquely specifying a path to be virtually released, is generated by providing a Path message of the RSVP with a new “PATH_PSEUDO_RELEASE” object.

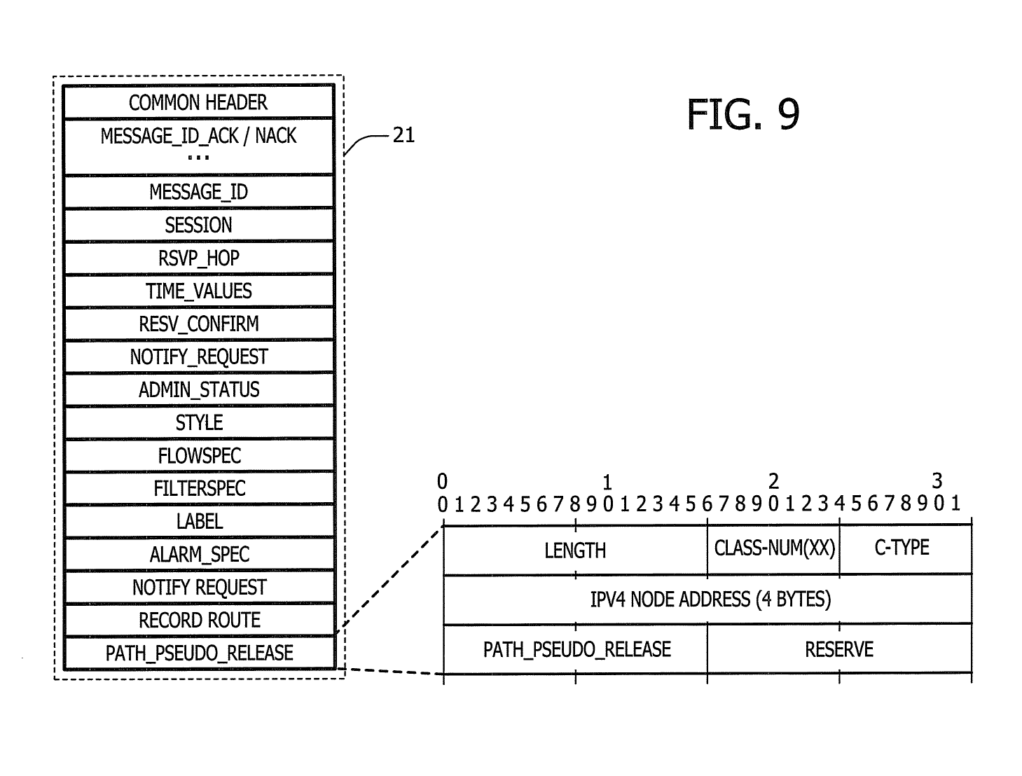

FIG. 9 is a diagram illustrating an example of a format of a virtual path-release Path message, according to an embodiment.

A virtual path-release Path message 21 includes “Common Header” (storing a code indicating a Path message), “MESSAGE_ID_ACK/NACK” (acknowledge/negative acknowledge), and “MESSAGE_ID” (message identifier) followed by “SESSION” that stores an identifier for specifying a path to be operated. “RSVP_HOP” is an existing “CALLID” object and stores route information of the existing path to be operated.

The new object “PATH_PSEUDO_RELEASE” includes “IPv4 Node Address” of an initial node and an instruction code “PATH_PSEUDO_RELEASE” along with “Length” indicating a length in bytes of the object, “Class-Num” indicating a major classification of the object, and “C-Type” indicating a sub-classification of the object.

The initial node that performs route computation transfers this virtual path-release Path message to downstream nodes to which an existing path is being set. This virtual path-release Path message is transferred to a terminal node along the route on which the existing path is being set.

For example, when a new link directly connecting the node #4 and the node #6 is set under the condition that an existing path P1 is being set on a route of a node #1 (connected to an initial point A), a node #4, a node #3, a node #7, a node #6, and a node #5 (connected to a terminal point Z) as depicted by a bold solid line in FIG. 7, a virtual path-release Path message is transferred from the node #1 (connected to the initial point A) to the node #5 (connected to the terminal point Z) on a hop-by-hop basis, through the node #4, the node #3, the node #7, and the node #6.

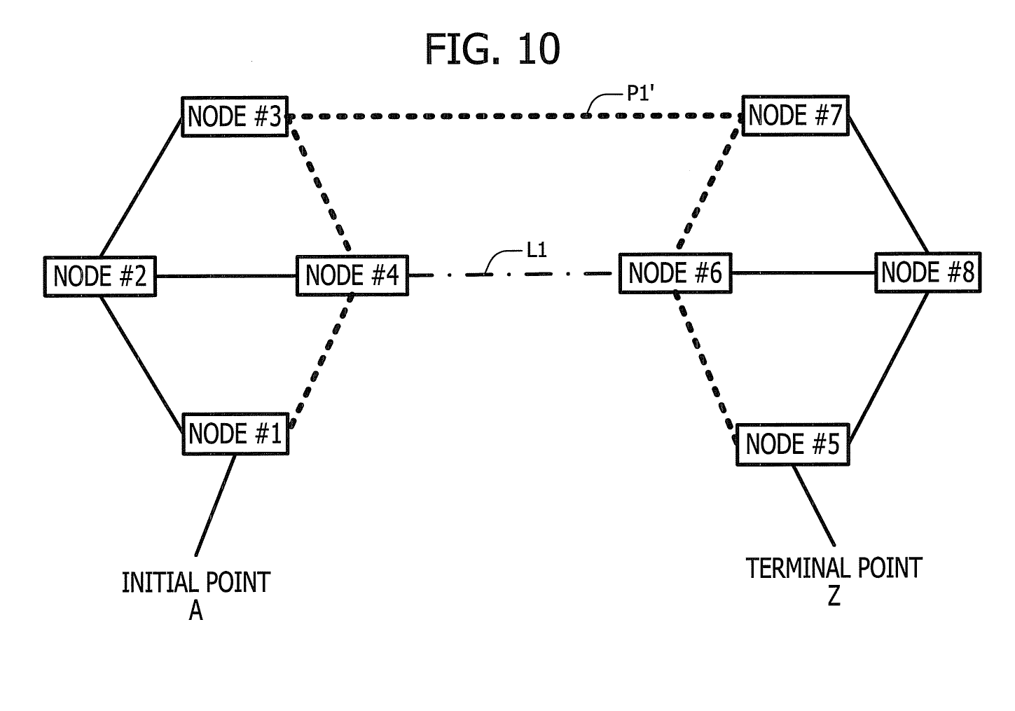

FIG. 10 is a diagram illustrating an example of a virtually released path, according to an embodiment.

Upon receiving the virtual path-release Path message, each of the down stream nodes generates virtual topology information in which links being used by the existing path are virtually released (removed) in accordance with the “PATH_PSEUDO_RELEASE” object stored in the virtual path-release Path message, stores the virtual topology information into the virtual LSA management table 126b, and advertises and synchronizes the virtual topology information in the network by using the OSPF protocol. Thus, as depicted by a dotted line P1′ in FIG. 10, the existing path P1 passing through the nodes #1, #4, #3, #7 #6 and #5 is virtually released.

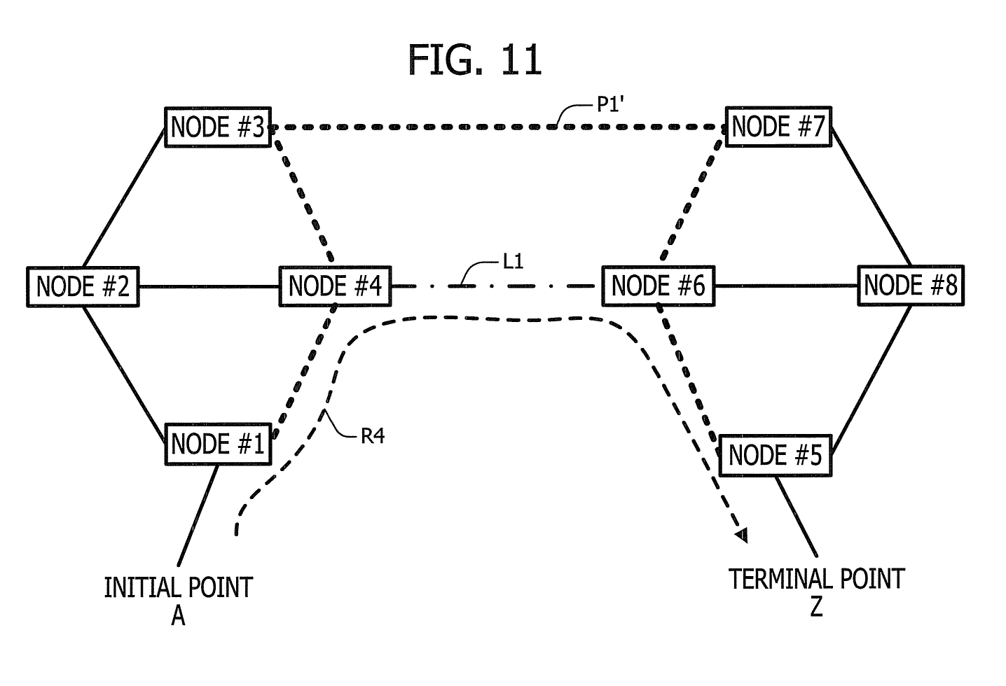

FIG. 11 is a diagram illustrating an example of an optimum route, according to an embodiment.

The initial node #1 performs route computation on the basis of the synchronized virtual topology information, thereby re-computing, as an optimum route, a shortest route from the node #1 (connected to the initial point A) to the node #5 (connected to the terminal point Z) through the node #4 and the node #6, as depicted by a dotted line R4 with an arrow in FIG. 11.

### Operation of Initial Node

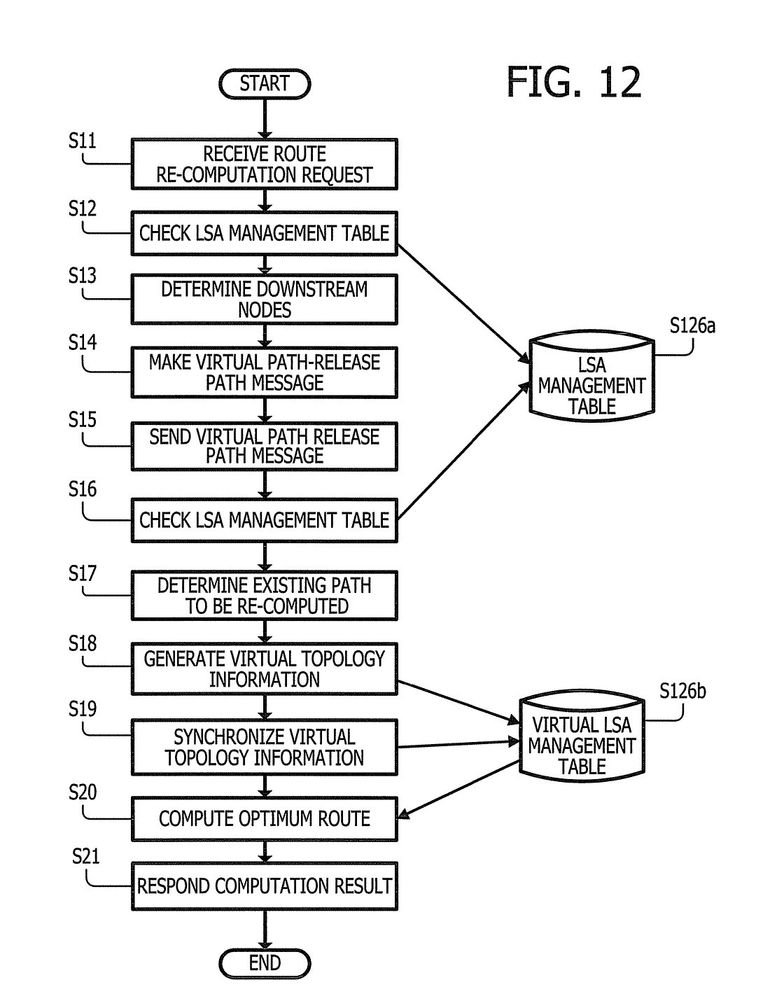

FIG. 12 is a diagram illustrating an example of a flowchart for re-computing a path by an initial node, according to an embodiment.

In step S11, when the initial node receives a route re-computation request according to the GMPLS via the monitor device 13, the received route re-computation request is sent to the GMPLS processor 122 through the user interface unit 111, the command processor 112, and the inter-CPU communication controllers 116, 121.

In step S12, the GMPLS processor 122 checks the LSA management table 126a storing the topology information of the network.

In step S13, the GMPLS processor 122 determines downstream nodes positioned along an existing path to be re-computed, by using the check result of the step S12, and obtains information on bandwidth used for the existing path.

In step S14, the GMPLS processor 122 makes a virtual path-release Path message, which includes a “PATH_PSEUDO_RELEASE” object (newly added object) requesting for virtually removing an existing path, and a “CALLID” object for uniquely specifying the existing path to be re-computed.

In step S15, the GMPLS processor 122 transfers the virtual path-release Path message to the downstream nodes determined in step S13, through the communication controller 123 and one of a the LAN controller 125 and the DCC controller 124.

Meanwhile, upon receiving the virtual path-release Path message, each of the downstream nodes positioned along the existing path computes virtual topology information on the basis of the received virtual path-release Path message. Upon completing the computation, the GMPLS processor 122 of the each of the downstream nodes makes an OSPF synchronization message for synchronizing the virtual topology information in the whole network, and transmits the OSPF synchronization message from the communication controller 123 to adjacent upstream and downstream nodes through the LAN controller 125 or the DCC controller 124.

In step S16, the GMPLS processor 122 of the initial node checks the LSA management table 126a storing the topology information of the network.

In step S17, the GMPLS processor 122 determines an existing path to be re-computed by using the check result of the step S16.

In step S18, the GMPLS processor 122 generates virtual topology information under the condition that the existing path to be re-computed is released, and stores the generated topology information into the virtual LSA management table 126b.

In step S19, the GMPLS processor 122 further makes an OSPF synchronization message for synchronizing the virtual topology information in the whole network, and transmits the OSPF synchronization message from the communication controller 123 to the adjacent downstream node through the LAN controller 125 or the DCC controller 124. In the case, the OSPF synchronization message is provided with a “PATH_PSEUDO_RELEASE” object requesting computation of virtual topology information.

Further, the initial node receives an OSPF synchronization message from each of the downstream nodes through the adjacent downstream node, and stores virtual topology information included in the received OSPF synchronization message into the virtual LSA management table 126b, thereby completing the synchronization of the virtual topology information in the whole network.

In step S20, the GMPLS processor 122 computes an optimum route from the initial node to the terminal node under the condition that links being used by the existing path to be re-computed is virtually removed, by using the virtual topology information in the virtual LSA management table 126b.

In step S21, the GMPLS processor 122 responds to the monitor device 13 with the result of the optimum route computation, through the inter-CPU communication controllers 121 and 116, the command processor 112, and the user interface 111.

### (Operation of Relay Node and Terminal Node)

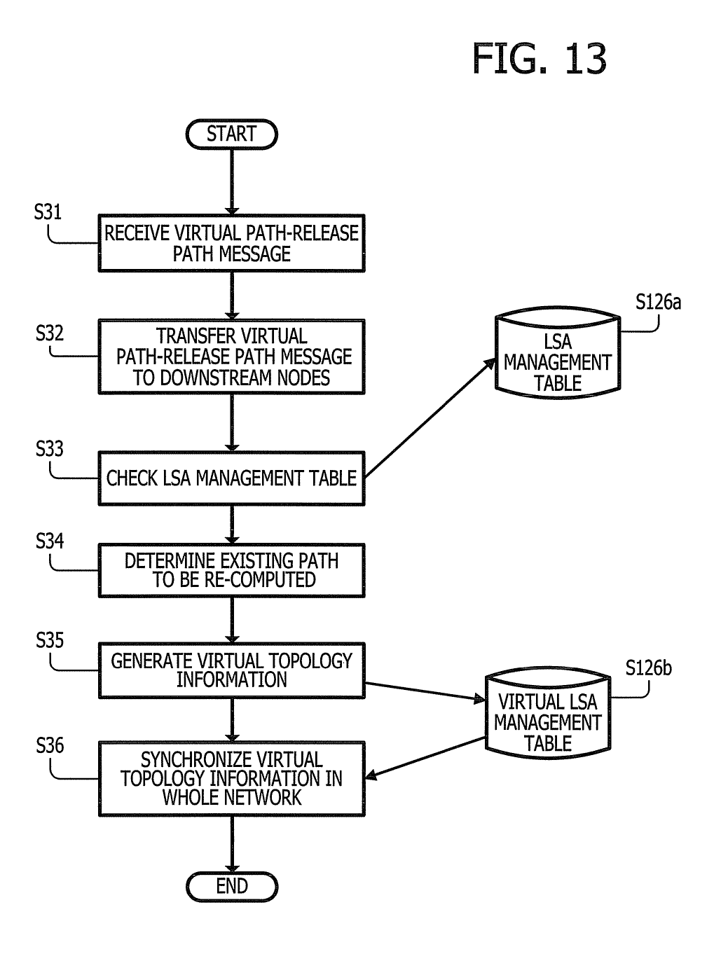

FIG. 13 is a diagram illustrating an example of a flowchart for re-computing a path by downstream nodes, according to an embodiment.

In step S31, each of the downstream nodes receives a virtual path-release Path message sent from upstream nodes through the DCC controller 124 or the LAN controller 125.

In step S32, in the case of a relay node (a node different from a terminal node), the received virtual path-release Path message is transferred to downstream nodes positioned along the existing path indicated by the received virtual path-release Path message, through the communication controller 123, and the LAN controller 125 or the DCC controller 124.

In step S33, the GMPLS processor 122 of the downstream nodes checks the LSA management table 126a.

In step S34, the GMPLS processor 122 of the downstream nodes determines an existing path to be re-computed on the basis of the “CALLID” object stored in the virtual path-release Path message, by using the check result of the step S33.

In step S35, the GMPLS processor 122 of the downstream nodes recognizes that the received virtual path-release Path message is requesting re-computation of the virtual topology information from the “PATH_RELEASE_PSEUDO” object stored in the virtual path-release Path message, and generates virtual topology information in which links being used by the existing path to be re-computed is virtually released. Then, the generated virtual topology information is stored into the virtual LSA management table 126b.

In step S36, the GMPLS processor 122 of the downstream nodes makes an OSPF synchronization message for synchronizing the generated virtual topology information in the whole network, and transmits the OSPF synchronization message from the communication controller 123 to the adjacent upstream and downstream nodes through the LAN controller 125 or the DCC controller 124. Here, the “PATH_RELEASE_PSEUDO” object indicating request for re-computing virtual topology information is stored in the OSPF synchronization message.

### (Operation Sequence of Re-Computation Process)

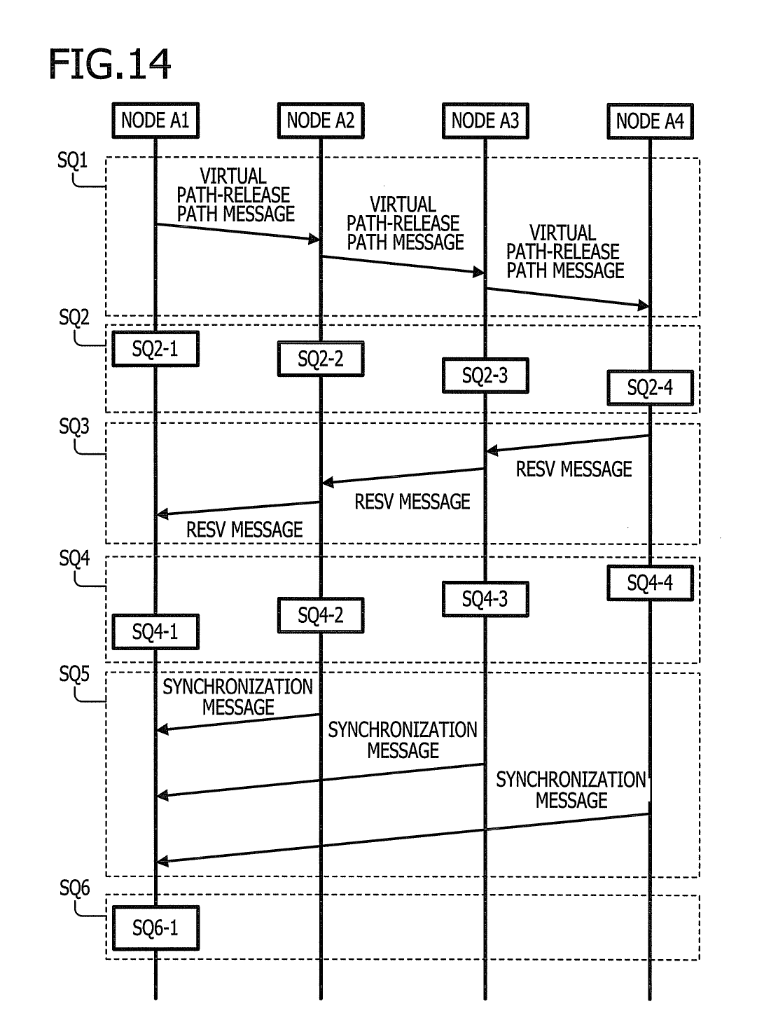

FIG. 14 is a diagram illustrating an example of an operation sequence of a route re-computation process, according to an embodiment, in which a re-computation process is performed on an existing path from an initial node A1 to a terminal node A4 through nodes A2, A3.

As depicted in FIG. 14, the initial node A1 makes a virtual path-release Path message, which is transferred to the down stream nodes A2, A3, and A4 on a hop-by-hop basis (in sequence SQ1). Upon receiving the virtual path-release Path message, each of the downstream nodes A2, A3, and A4 starts computation of virtual topology information (in SQ2-1, SQ2-2, SQ2-3, and SQ2-4 of sequence SQ2), and transfers a Resv message to the node A1 (in step SQ3).

Thereafter, each of the nodes A1, A2, A3, and A4 completes computation of virtual topology information (in SQ4-1, SQ4-2, SQ4-3, and SQ4-4 of sequence SQ4), and advertizes and synchronizes the computed (generated) virtual topology information by transmitting OSPF synchronization messages among the nodes (in sequence SQ5). In the case, although OSPF synchronization messages are transmitted and received among the nodes A1, A2, A3, and A4, FIG. 14 depicts only the transmission of the OSPF synchronization messages to the initial node A1 for convenience of explanation.

Upon completing synchronization of virtual topology information with all the downstream nodes A2, A3, and A4, the initial node A1 computes an optimum route from the initial node to the terminal node under the condition that links being used by the existing path (passing through the nodes A1, A2, A3, and A4) is virtually removed, by using the virtual topology data stored in the virtual LSA management table 126b (in SQ6-1 of sequence SQ6).

As described above, synchronizing virtual topology information among all the relevant nodes enables the virtual topology information to be more reliable.

### Operation Sequence of Path Switchover Process

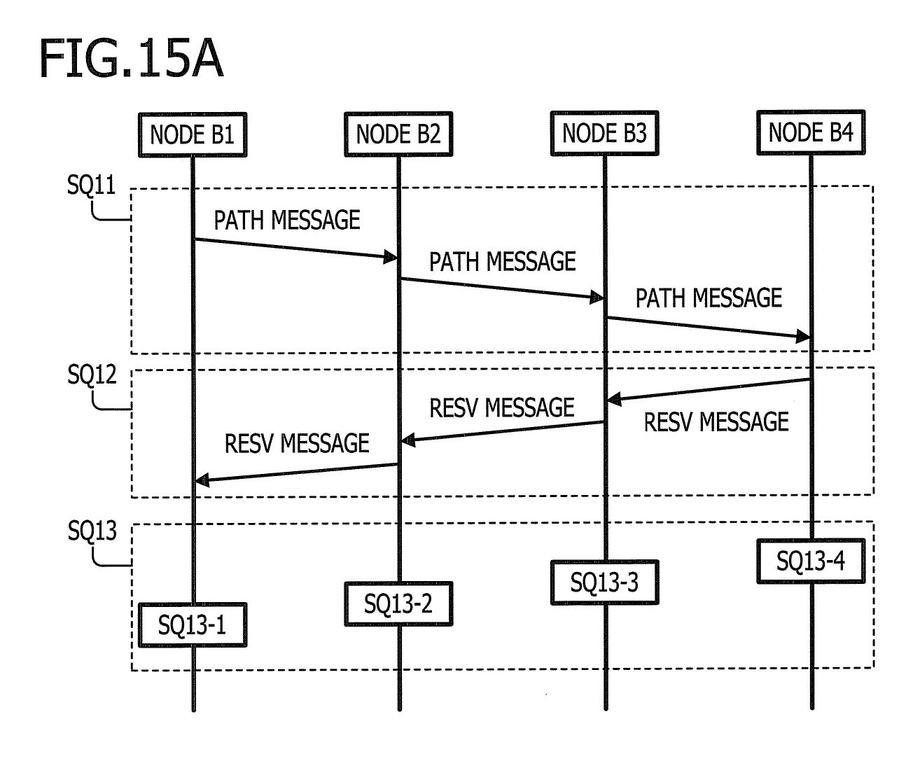

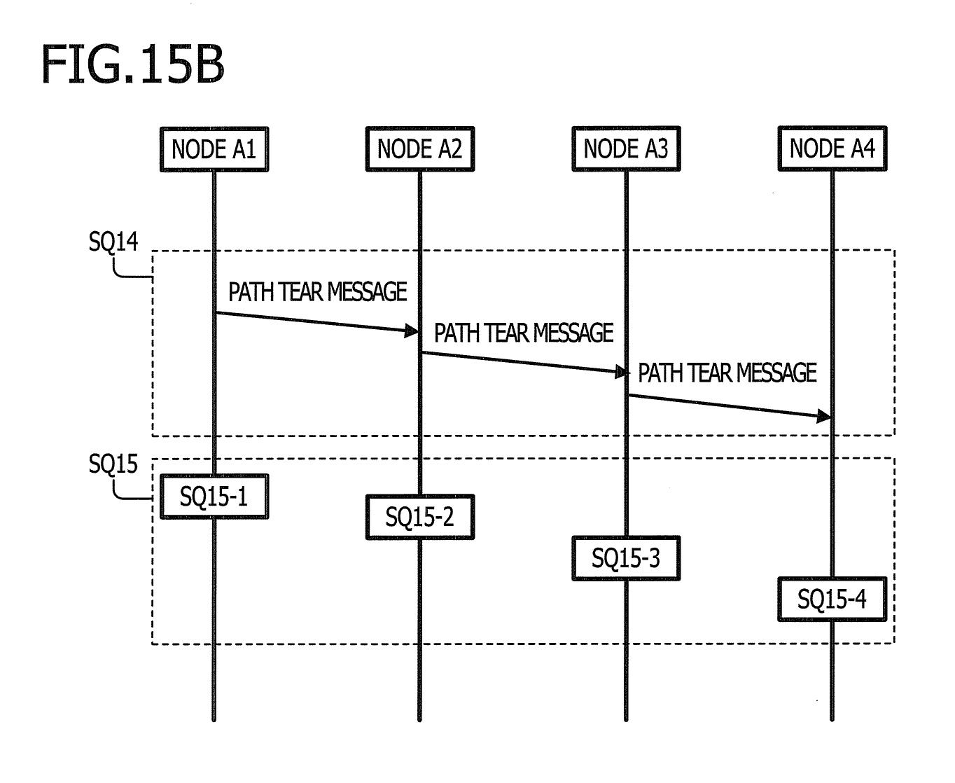

FIG. 15A is a diagram illustrating an example of an operation sequence of a path switching process, according to an embodiment. This operation sequence is performed after the operation sequence depicted in FIG. 14 is completed, so as to switch over the existing path to the newly computed route. In FIG. 15A, it is assumed that a route to which a new path is set instead of the existing path is the route of nodes B1, B2, B3, and B4 which is generally different from the route of nodes A1, A2, A3, and A4 depicted in FIG. 14.

In FIG. 15A, the initial node B1 makes a Path message for setting a new path, which is transferred to the downstream nodes B2, B3, and B4 in this order on a hop-by-hop basis (in sequence SQ11). Upon receiving the Path message, the downstream nodes B4, B3, and B2 transfer Resv messages back to the initial node B1 (in step SQ12).

The node at which a new path branches off from the existing path, for example, the node B1 in FIG. 15A, generates cross-connect data (XCON) such that a broadcast is set (in SQ13-1 of sequence SQ13). The node at which a new path uses the same route as the existing path, for example, the node B2 in FIG. 15A, simply rewrites the path identifier into a new path identifier (in SQ13-2 of sequence SQ13). The node that is not included in the existing path, for example, the node B3 in FIG. 15A, generates cross-connect data (XCON) such that a new path is set (in SQ13-3 of sequence SQ13). The node at which a new path and the existing path join together, for example, the node 84 in FIG. 15, generates cross-connect data (XCON) such that PSW (APS Path Switch) is set (in SQ13-4 of sequence SQ13).

Thus, the new path is set as an end-to-end path connecting initial node B1 and terminal node B4 through nodes B2 and B3.

FIG. 15B is a diagram illustrating an example of an operation sequence of a path release process, according to an embodiment. This operation sequence is performed after the operation sequence depicted in FIG. 15A is completed so as to release the existing path. In FIG. 15B, it is assumed that the existing path passing through the route of nodes A1, A2, A3, and A4 is released.

The node A1 transfers a PathTear message for releasing the existing path to the downstream nodes A2, A3, and A4 in this order on a hop-by-hop basis (in sequence SQ14).

Thereafter, the node at which the new path branches off from the existing path, for example, the node A1, releases the existing path (in SQ15-1 of sequence SQ15). The node at which the new path uses the same route as the existing path, for example, the node A2, does nothing since the path identifier has been already rewritten into a new path identifier in the operation sequence of the path switching process described before (in SQ15-2 of sequence SQ15). The node that is not included in the new path, for example, the node A3, simply release the existing path (in SQ15-3 of sequence SQ15). The node at which the new path and the existing path join together, for example, the node A4, release the existing path (in SQ15-4 of sequence SQ15).

### Second Embodiment

According to a second embodiment, there is provided a virtual path release Notify message by providing a Notify message of the RSVP with a new “PATH_PSEUDO_RELEASE” object that stores information “CALLID” for uniquely specifying an existing path to be virtually released.

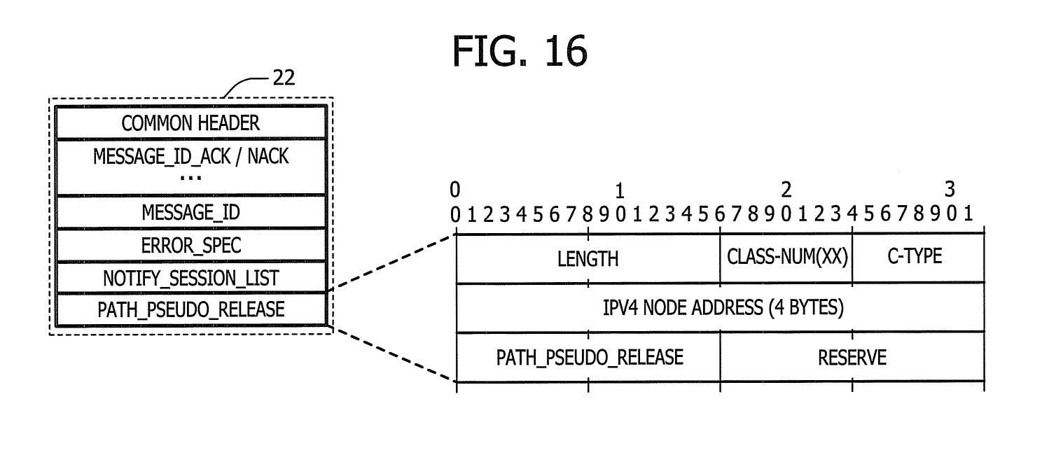

FIG. 16 is a diagram illustrating an example of a configuration of a virtual path release Notify message, according to an embodiment.

A virtual path release Notify message 22 includes “Common Header” (including a code identifying a Notify message), “MESSAGE_ID_ACK/NACK” (acknowledge/negative acknowledge), “MESSAGE_ID” (message identifier), “ERROR_SPEC” (error identifier: unused in the case), “Notify_session_list” (list of error link: unused in the case), and a new object “PATH_PSEUDO_RELEASE”.

The new object “PATH_PSEUDO_RELEASE” includes “Length” indicating a length in bytes of the object, “Class-Num” indicating a large classification of the object, “C-Type” indicating a small classification of the object, an IPv4 Node Address of an initial node, and an instruction code “PATH_PSEUDO_RELEASE”.

The initial node that performs route computation transmits the virtual path release Notify message to each of downstream nodes positioned along the existing path to be virtually released.

Upon receiving this virtual path release Notify message, each of the downstream nodes positioned along the existing path generates virtual topology information in which links being used by the existing path is virtually removed, in accordance with the “PATH_PSEUDO_RELEASE” object in the virtual path release Notify message, stores the generated virtual topology information into the virtual LSA management table 126b, and advertises and synchronizes the virtual topology information in the whole network by using the OSPF protocol.

The initial node performs route computation on the basis of the synchronized virtual topology information, thereby re-computing an optimum route that can replace the existing path while keeping the existing path unchanged.

### (Operation of Initial Node)

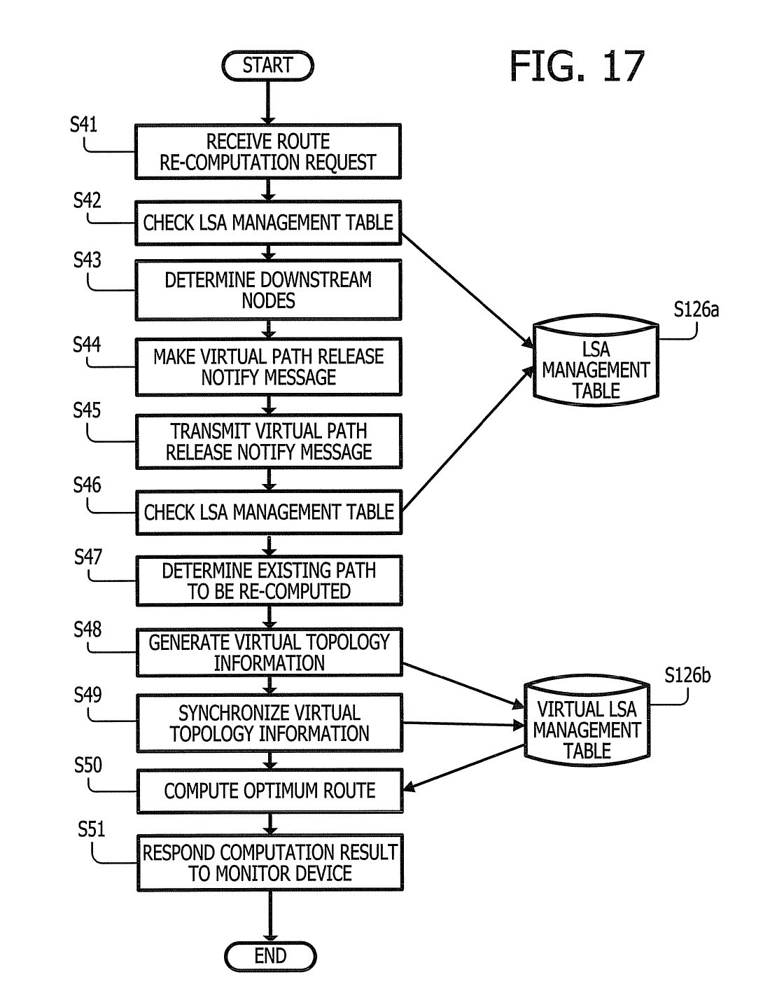

FIG. 17 is a diagram illustrating an example of an operation sequence of a route re-computation process performed by an initial node, according to an embodiment.

In step S41, when the initial node receives a route re-computation request according to the GMPLS from the monitor device 13, the route re-computation request is sent to the GMPLS processor 122 through the user interface 111, the command processor 112, and the inter-CPU communication controllers 116, 121.

In step S42, the GMPLS processor 122 checks the LSA management table 126a storing the topology information of the network.

In step S43, the GMPLS processor 122 determines downstream nodes along an existing path to be re-computed by using the check result of step S42, and obtains information on bandwidth used for the existing path.

In step S44, the GMPLS processor 122 makes a virtual path-release Notify message by providing a Notify message with a “PATH_PSEUDO_RELEASE” object (new object) indicating a request for virtually removing an existing path and a “CALLID” object (known object) uniquely specifying the existing path to be re-computed.

In step S45, the GMPLS processor 122 transmits the generated virtual path-release Notify message to each of the downstream nodes positioned along the existing path to be re-computed, thorough the communication controller 123 and one of the LAN controller 125 or the DCC controller 124.

Upon receiving the virtual path release Notify message, each of the downstream nodes positioned along the existing path computes virtual topology information on the basis of the received virtual path release Notify message. Upon completing the computation of the virtual topology information, the GMPLS processor 122 of each of the downstream nodes makes an OSPF synchronization message for synchronizing virtual topology information in the whole network, and sends the OSPF synchronization message from the communication controller 123 to adjacent upstream and downstream nodes through the LAN controller 125 or the DCC controller 124.

In step S46, the GMPLS processor 122 of the initial node checks the LSA management table 126a storing the topology information of the network.

In step S47, the GMPLS processor 122 determines an existing path to be re-computed by using the check result of the step S46.

In step S48, the GMPLS processor 122 generates virtual topology information in which links being used by the existing path to be re-computed is virtually released, and stores the generated virtual topology information into the virtual LSA management table 126b.

In step S49, the GMPLS processor 122 makes an OSPF synchronization message for synchronizing the virtual topology information in the whole network, and transmits the OSPF synchronization message from the communication controller 123 to the adjacent downstream node through the LAN controller 125 or the DCC controller 124. In the case, a “PATH_PSEUDO_RELEASE” object indicating a request for computation of virtual topology information is added to the OSPF synchronization message.

The initial node receives an OSPF synchronization message from each of the downstream nodes, and stores the received virtual topology information in the received OSPF synchronization message into the virtual LSA management table 126b, thereby completing the synchronization of the virtual topology information in the whole network.

In step S50, the GMPLS processor 122 computes an optimum route from the initial node to the terminal node under the condition that links being used by the existing path to be re-computed is virtually removed, by using the virtual topology information stored in the virtual LSA management table 126b.

In step S51, the GMPLS processor 122 responds to the monitor device 13 with the result of the optimum route computation, through the inter-CPU communication controllers 121, 116, and the user interface unit 111.

### (Operation Sequence of Re-Computation Process)

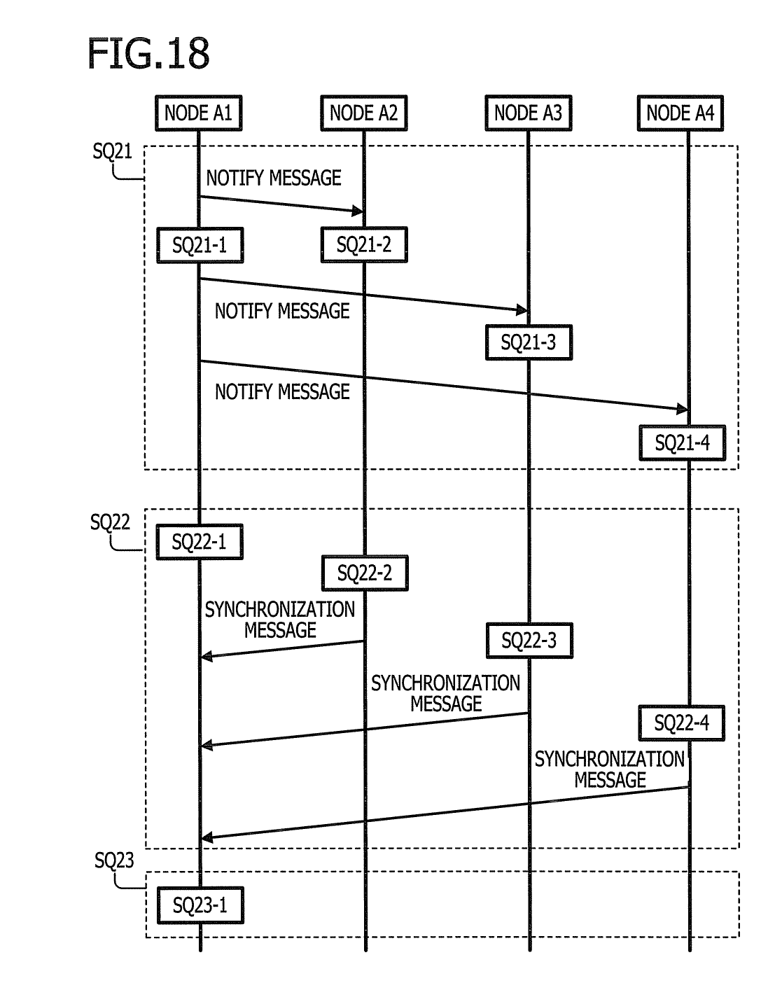

FIG. 18 is a diagram illustrating an example of an operation sequence of a route re-computation process, according to an embodiment, in which a re-computation process is performed on an existing path from an initial node A1 to a terminal node A4 through nodes A2, A3.

As depicted in FIG. 18, the initial node A1 makes a virtual path release Notify message which is then transmitted to each of the downstream nodes A2, A3, and A4, on a point-to-point basis, and starts computation of virtual topology information (in SQ21-1 of sequence SQ21). At the same time, upon receiving the virtual path release Notify message, each of the downstream nodes A2, A3, and A4 also starts computation of respective virtual topology information (in SQ21-2, SQ21-3, and SQ21-4 of sequence SQ21).

Upon completion of computing virtual topology information, each of the nodes Al, A2, A3, and A4 sends and receives an OSPF synchronization message so as to advertize and synchronize the virtual topology data (in SQ22-1, SQ22-2, SQ22-3, SQ22-4 of sequence SQ22). Here, although OSPF synchronization messages are actually transferred among all the nodes A1, A2, A3, and A4, FIG. 18 depicts OSPF synchronization messages regarding only the initial node A1 for convenience of explanation.

Upon completing synchronization with all the downstream nodes A2, A3 and A4, the initial node A1 computes an optimum route from the initial node to the terminal node under the condition that links being used by the existing path to be re-computed is virtually removed, by using the virtual topology information stored in the virtual LSA management table 126b (in SQ23-1 of sequence SQ23).

After completing the above operation sequence, the operation sequence of the path switching process depicted in FIG. 15A is performed.

The first and second embodiments described above can be easily implemented by defining the virtual path-release Path message or the virtual path-release Notify message and securing the virtual LSA management table 126b in the database 126. However, the virtual topology information needs to be advertized and synchronized among all the nodes from the initial node to the terminal node positioned along the existing path.

On the other hand, according to a third embodiment described below, only the initial node performs re-computation of an optimum route. Thus, although operation of the GMPLS controller 122 of the initial node needs to be modified from the operation of the ordinary GMPLS controller 122, it is made unnecessary to advertize and synchronize the virtual topology information among all the relevant nodes, and the optimum route can be computed at high speed.

### Third Embodiment

According to the third embodiment, the initial node that performs route computation generates virtual topology information in which links being used by the existing path to be re-computed is virtually released, on the basis of topology information held in the own node.

The initial node performs route computation on the basis of the generated virtual topology information, thereby re-computing an optimum route that can replace the existing path while keeping the existing path unchanged.

### (Operation of Initial Node)

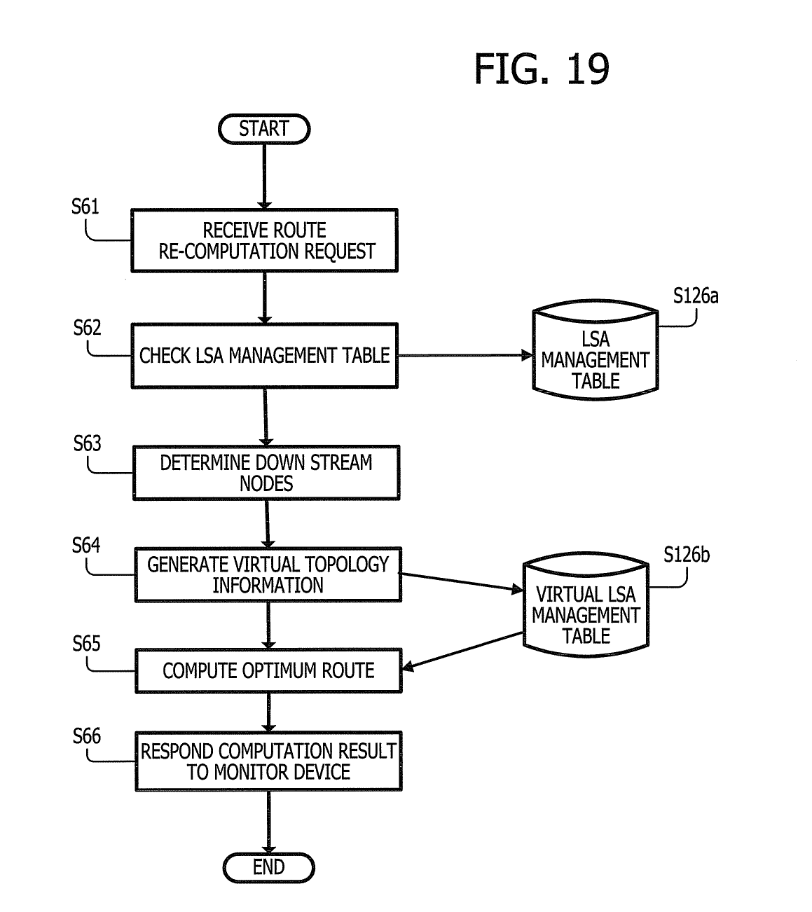

FIG. 19 is a diagram illustrating an example of a flowchart for re-computing an existing path, according to an embodiment.

In step S61, when the node apparatus receives a route re-computation request according to the GMPLS through the monitor device 13, the route re-computation request is sent to the GMPLS processor 122 through the user interface unit 111, the command processor 112, and the inter-CPU communication controllers 116, 121.

In step S62, the GMPLS processor 122 checks the LSA management table 126a storing topology information of the network.

In step S63, the GMPLS processor 122 determines downstream nodes positioned along the existing path to be re-computed, by using the check result of the step S62, and obtains information on bandwidth used for the existing path.

In step S64, the GMPLS processor 122 generate virtual topology information in which links being used by the existing path to be re-computed is virtually released, and stores the generated virtual topology information into the virtual LSA management table 126b.

In step S65, the GMPLS processor 122 computes an optimum route from the initial node to the terminal node under the condition that the existing path to be re-computed is removed, by using the virtual topology information stored in the virtual LSA management table 126b.

In step S66, the GMPLS processor 122 responds to the monitor device 13 with the result of the optimum route computation, through the inter-CPU communication controllers 121, 116, the command processor 112, and the user interface 111.

### (Operation Sequence of Re-Computation Process)

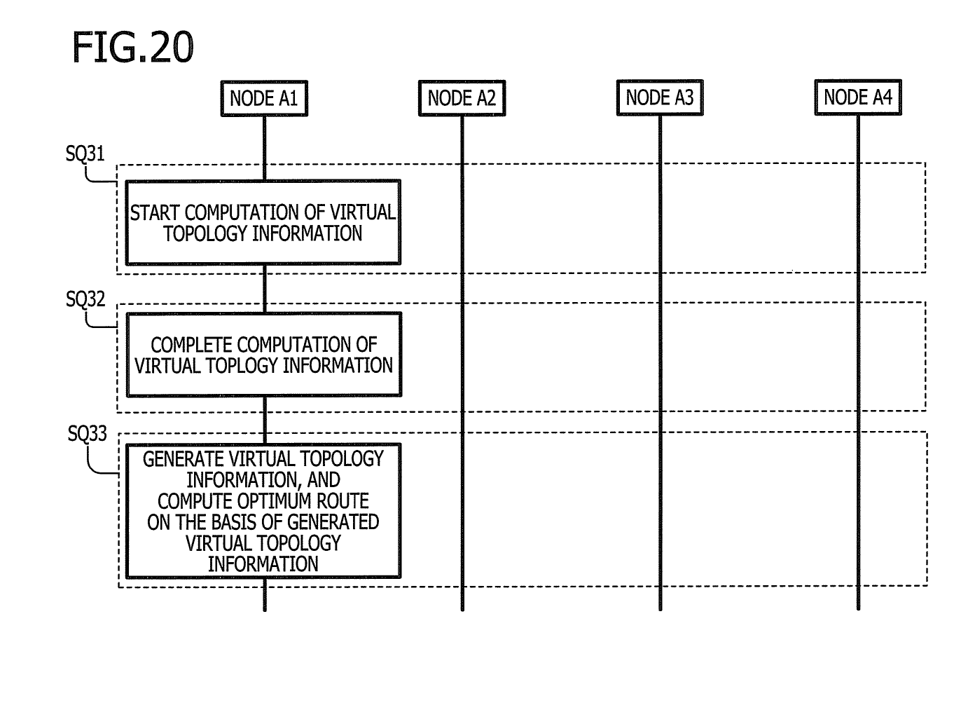

FIG. 20 is a diagram illustrating an example of an operation sequence of a route re-computation process, according to an embodiment, in which a re-computation process is performed on an existing path from an initial node A1 to a terminal node A4 through nodes A2, A3.

As depicted in FIG. 20, the initial node A1 starts computation of virtual topology information (in sequence SQ31).

Thereafter, the initial node A1 completes the computation of virtual topology information (in sequence SQ32).

Then, The initial node A1 stores the virtual topology information generated by computation of the sequence SQ31 and SQ32 into the virtual LSA management table 126b, and computes an optimum route from the initial node to the terminal node under the condition that links being used by the existing path to be re-computed is virtually removed, by using the virtual topology information stored in the virtual LSA management table 126b (in sequence SQ33).

After completion of the operation sequence mentioned above, the operation sequence of the path switchover process depicted in FIG. 15A is performed.

According to the embodiments described above, an optimum route capable of replacing the existing path can be re-computed while keeping the existing path in operation unchanged, thereby maintaining optimum use efficiency of a network even when the network topology was modified due to a change in the network configuration.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A node apparatus for calculating a route between a pair of nodes in a communication network, comprising:
a topology table for storing topology information on links being used by an existing path in the communication network;
a controller for generating a virtual topology table storing topology information in which links being used by the existing path are virtually released and made unused,
wherein the controller computes an optimum route for a path connecting a pair of nodes in the communication network on the basis of the virtual topology table.

2. The node apparatus of claim 1, wherein
the controller provides nodes positioned along the existing path with a virtual path-release Path message for instructing the nodes positioned along the existing path to virtually release links being used by the existing path, and synchronizes topology information in the virtual topology table with virtual topology information, advertised by the nodes positioned along the existing path, in which links being used by the existing path are virtually released.

3. The node apparatus of claim 2, wherein
the controller provides the nodes positioned along the existing path with the virtual path-release Path message by transferring the virtual path-release Path message among the nodes positioned along the existing path on the hop-by-hop basis.

4. The node apparatus of claim 2, wherein
the controller provides the nodes positioned along the existing path with the virtual path-release Path message by transmitting the virtual path-release Path message to each of the nodes positioned along the existing path on the point-to-point basis.

5. A method for calculating an optimum route for calculating a route between a pair of nodes in a communication network, comprising:
providing a topology table for storing topology information on links being used by an existing path in the communication network;
generating a virtual topology table for storing topology information in which links being used by the existing path are virtually released and made unused; and
computing an optimum route for a path connecting a pair of nodes in the communication network on the basis of the virtual topology table.

6. The method of claim 5, further comprising:
providing nodes positioned along the existing path with a virtual path-release Path message for instructing the nodes positioned along the existing path to virtually release links being used by the existing path; and
synchronizing topology information in the virtual topology table with virtual topology information advertised by the nodes positioned along the existing path,
wherein links being used by the existing path are virtually released in the advertised virtual topology information.

7. The method of claim 6, wherein
the nodes positioned along the existing path are provided with the virtual path-release Path message by transferring the virtual path-release Path message among the nodes positioned along the existing path on the hop-by-hop basis.

8. The method of claim 6, wherein
the nodes positioned along the existing path are provided with the virtual path-release Path message by transmitting the virtual path-release Path message to each of the nodes positioned along the existing path on the point-to-point basis.
